(19) United States
(12) Patent Application Publication
(10) Pub. No.: US 2003/0060561 A1
(43) Pub. Date: Mar. 27, 2003

(54) Curable resin composition

(76) Inventors: Hiroyuki Okuhira, Kanagawa (JP); Akihito Kanemasa, Kanagawa (JP); Masaki Yamamoto, Kanagawa (JP)

Correspondence Address: David T. Nikaido, RADER, FISHMAN & GRAUER, PLLC, Suite 501, 1233 20th Street, NW, Washington, DC, 20036, US

(21) Appl. No.: 10/206,098

(22) Filed: Jul. 29, 2002

(30) Foreign Application Priority Data
Aug. 3, 2001 (JP) 2001-236747

(51) Int. Cl. C08K 3/00

(52) U.S. Cl. 524/589

(57) ABSTRACT

A one-pack curable resin composition contains a blocked urethane comprising an urethane prepolymer having an isocyanate group which is bonded to a secondary or tertiary aliphatic carbon atom, and is blocked with a secondary amine having a substituent which is bonded to a carbon atom at an α-position of the nitrogen atom of the amine, and an amine latent curing agent. A two-pack curable resin composition contains the above described blocked urethane and an amine curing agent. These curable resin compositions are excellent in storage stability and maintain suitable usable lives under high temperature and high humidity conditions.

### BACKGROUND OF THE INVENTION

1. Field of the Invention

The present invention relates to a one-pack or two-pack curable resin composition containing a blocked urethane that can be unblocked to reproduce an isocyanate group in the presence of an amine curing agent.

2. Description of the Related Art

A lot of one-pack or two-pack polyurethane curable resin compositions are known. For example, one-pack polyurethane curable resin compositions include those compositions containing an urethane prepolymer and a latent curing agent such as a ketimine and an oxazolidine. The curing of the compositions occurs by the reaction between the urethane prepolymer and an amine reproduced as a result of hydrolysis of the latent curing agent due to the moisture in the air. Although they are not blowing properties but they have problems that they have poor storage stabilities, particularly under a high temperature not lower than 40° C. and high humidity in the summer period and that it is difficult to maintain their suitable usable lives.

Likewise, in the case of two-pack compositions, in which an urethane prepolymer and a curing agent such as an amine, an acid or an acid anhydride are mixed at the time of use, the urethane prepolymer may react with the moisture in the air during storage, so that they have insufficient storage stabilities and usable lives.

### SUMMARY OF THE INVENTION

An object of the present invention is to provide a one-pack or two-pack curable resin composition that has excellent storage stability and maintains a suitable usable life (operating time) under high temperature and high humidity conditions.

As a result of extensive studies, the inventors of the present invention have found that a blocked urethane that comprises an urethane prepolymer having an isocyanate group of a particular structure blocked with a secondary amine of a particular structure is unblocked at room temperature due to the presence of an amine curing agent, and an exchange reaction in which the blocking secondary amine is replaced by the amine curing agent takes place. Also the inventors of the present invention have found that a one-pack or two-pack curable resin composition obtained by utilizing this exchange reaction is curable at room temperature and can solve the problems associated with the prior art, and therefore achieved the present invention.

According to a first aspect of the present invention, there is provided a one-pack curable resin composition comprising: a blocked urethane prepolymer comprising an urethane prepolymer having an isocyanate group which is bonded to a secondary or tertiary aliphatic carbon atom, and is blocked with a secondary amine having a substituent which is bonded to a carbon atom at an α-position of the nitrogen atom of the amine, and an amine latent curing agent.

In the first aspect of the present invention, it is preferable that the secondary amine is a secondary amine having a methyl group bonded to each of the two α-carbon atoms adjacent to the nitrogen atom of the amine.

Also, it is preferable that the amine latent curing agent is a compound selected from the group consisting of a ketimine and an aldimine.

Further, it is preferable that the compound selected from the group consisting of a ketimine and an aldimine is derived from a ketone or an aldehyde having a substituent at an α-carbon atom of a carbonyl carbon atom in the ketone or aldimine.

According to a second aspect of the present invention, there is provided a two-pack curable resin composition comprising: a blocked urethane prepolymer comprising an urethane prepolymer having an isocyanate group which is bonded to a secondary or tertiary aliphatic carbon atom, and is blocked with a secondary amine having a substituent which is bonded to a carbon atom at an α-position of the nitrogen atom of the amine, and an amine curing agent.

In the second aspect of the present invention, it is preferable that the secondary amine is a secondary amine having a methyl group bonded to each of the two α-carbon atoms adjacent to the nitrogen atom of the amine.

According to a third aspect of the present invention, there is provided a cured (molded) product produced from the curable resin composition of the first aspect or the second aspect of the invention.

### BRIEF DESCRIPTION OF THE DRAWINGS

FIG. 1 is a diagram illustrating a ¹H-NMR chart of tetramethylxylylene diisocyanate blocked with diisopropylamine;

FIG. 2 is a diagram illustrating a ¹H-NMR chart of tetramethylxylylene diisocyanate blocked with diisopropylamine after 1 hour from mixing n-butylamine therewith; and

FIG. 3 is a diagram illustrating a ¹H-NMR chart of tetramethylxylylene diisocyanate blocked with diisopropylamine after 18 hours from mixing n-butylamine therewith.

### DETAILED DESCRIPTION OF THE PREFERRED INVENTION

The present invention utilizes the above-mentioned exchange reaction in which the secondary amine blocking the blocked urethane is exchanged for an amine curing agent. The exchange reaction can be recognized by the following experiments using model compounds.

An experiment was performed as follows. In a sample tube were charged a compound (formula (1)) including tetramethylxylylene diisocyanate (TMXDI) which has an isocyanate group bonded to a tertiary aliphatic carbon atom, and is blocked with diisopropylamine (DIPA) (formula (2)), which is a secondary amine having a substituent bonded to the carbon atom at the α-position of the nitrogen atom of the amine, and n-butylamine (NBA), which is a primary amine, to prepare a sample. Then, the state of the sample with a lapse of time was observed by ¹H-NMR.

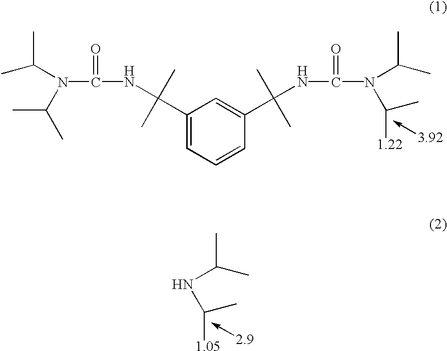

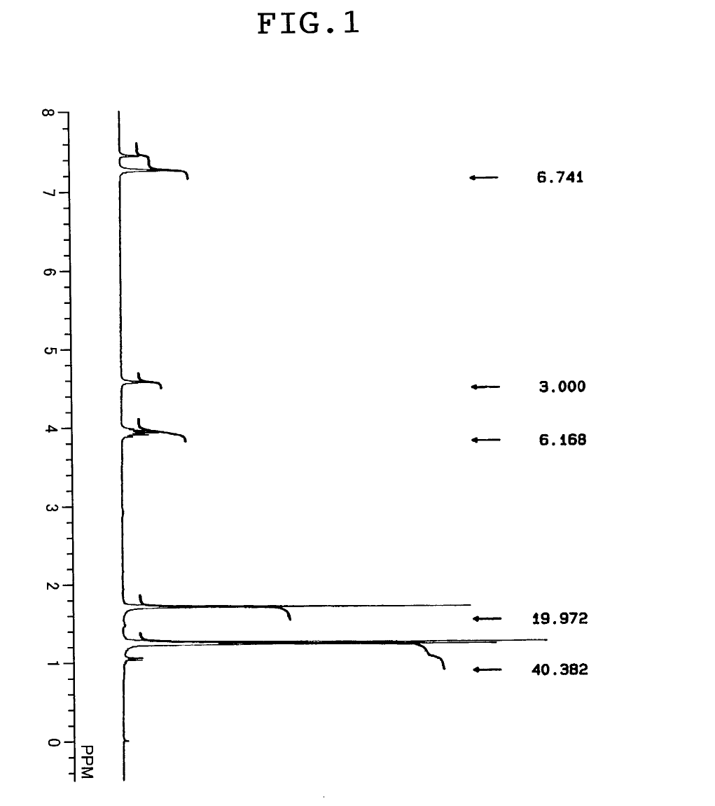

Hereinafter, explanation will be made with reference to FIGS. 1 to 3.

FIG. 1 is a ¹H-NMR chart of TMXDI blocked with DIPA. DIPA, a blocking agent, remained unreacted in a small amount. To this was added n-butylamine, and this state was taken as zero time.

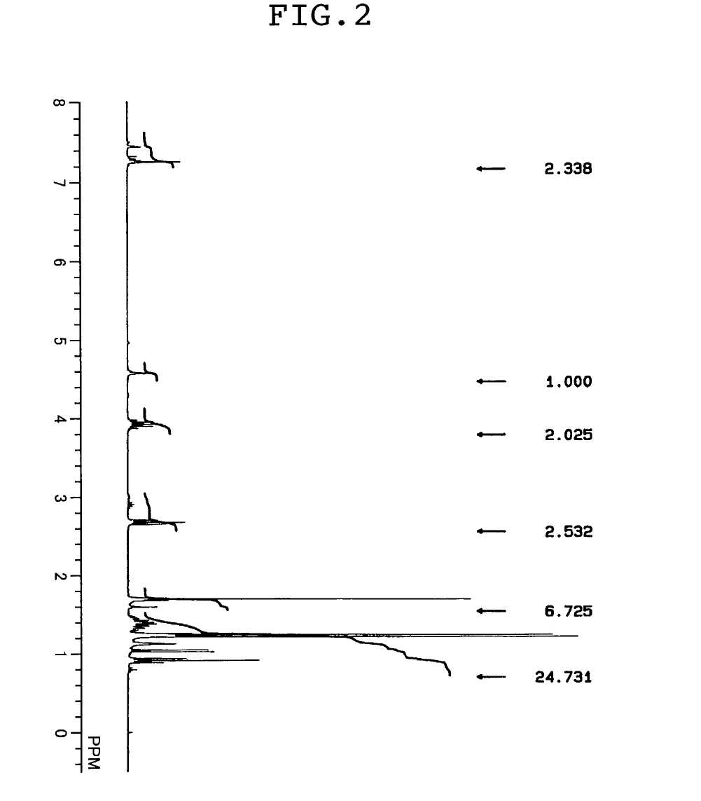

FIG. 2 is a ¹H-NMR chart after 1 hour. The isopropyl group in a blocked state (1.22 ppm, 3.92 ppm) was partly shifted to 1.05 ppm and 2.9 ppm, respectively. This indicates that DIPA was partly released. At the same time, the methyl group of NBA (0.92 ppm) was partly shifted to 0.8 ppm, which indicates that the primary amine was reacted. From the integrated ratio, it was revealed that the exchange reaction of about 10% took place.

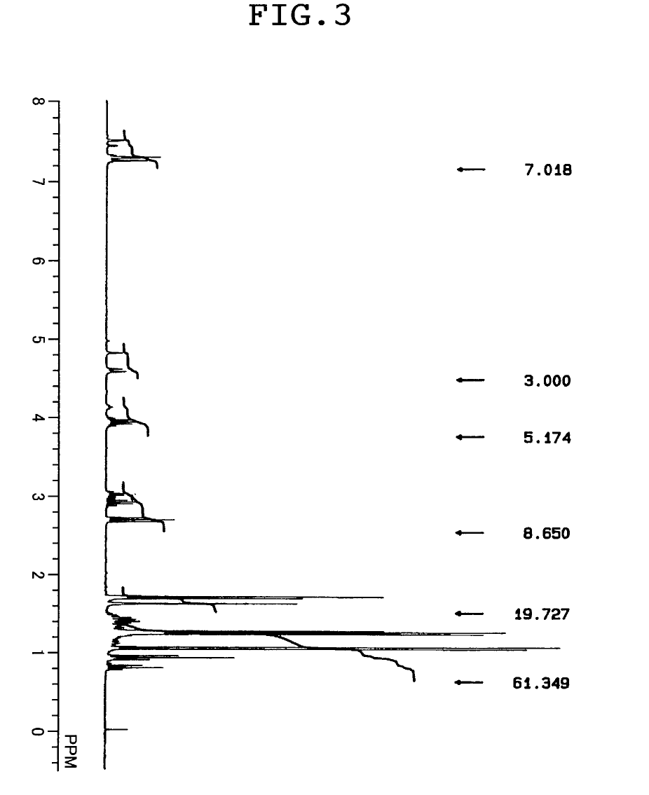

FIG. 3 is a ¹H-NMR chart after 18 hours. A similar shift to that in FIG. 2 was observed and from the integrated ratio, it was revealed that the exchange reaction of about 30% took place.

As stated above, it was revealed that the blocked urethane comprising a compound having an isocyanate group which is bonded to the tertiary aliphatic carbon atom, and is blocked with a secondary amine of a particular structure is unblocked due to the presence of n-butylamine to reproduce an isocyanate group, and an exchange reaction in which the isocyanate group reacts with the n-butylamine takes place.

It should be noted that since the above-mentioned reaction uses a model compound, the isocyanate compound that reacted with the primary amine became solid, which made it difficult for the reaction to proceed. This may be considered to be the reason that in spite of 10% exchange reaction attained in 1 hour, the exchange reaction reached only about 30% after 18 hours. It may be conceived that similar experiments in a solution or with an urethane prepolymer could result in an exchange reaction in a shorter time with a higher probability.

The present invention is intended to provide the curable resin compositions as described below, which have excellent storage stabilities even under high temperature and high humidity conditions by utilizing the above-mentioned exchange reaction in first and second aspects of the present invention. Hereinafter, each of the aspects of the present invention will be described.

The one-pack curable resin composition according to the first aspect of the present invention contains a blocked urethane comprising an urethane prepolymer having an isocyanate group which is bonded to a secondary or tertiary aliphatic carbon atom, and is blocked with a secondary amine having a substituent which is bonded to a carbon atom at an α-position of the nitrogen atom of the amine, and an amine latent curing agent.

The urethane prepolymer that serves as a starting material of the blocked urethane used in the first aspect of the present invention is not particularly limited so far as it is a compound that has at least one isocyanate group bonded to a secondary or tertiary aliphatic carbon atom. Such urethane prepolymers can be obtained by reaction between a polyisocyanate having an isocyanate group bonded to a secondary or tertiary aliphatic carbon atom and a polyol.

The polyisocyanate is not particularly limited so far as it is a compound having at least one isocyanate group bonded to a secondary or tertiary aliphatic carbon atom. Such polyisocyanates may be used singly or as combinations of two or more of them.

Specific examples thereof include aliphatic polyisocyanates such as tetramethylxylene diisocyanate (TMXDI), lysine diisocyanate (LDI), lysine ester triisocyanate, 1,3,6-hexamethylenetriisocyanate; alicyclic polyisocyanates such as isophorone diisocyanate (IPDI) and H₁₂MDI (hydrogenated MDI); isocyanurate forms, biuret forms, and polyhydric alcohol adducts of these polyisocyanates, etc.

Preferred examples of the isocyanurate forms of polyisocyanate include isocyanurate forms such as isophorone diisocyanate and tetramethylxylene diisocyanate.

Preferred examples of the polyhydric alcohol adducts of polyisocyanate include TMXDI/TMP adduct (formula (3)) derived from 1,1,1-trimethylolpropane (TMP) and tetramethylxylylene diisocyanate (TMXDI), etc.

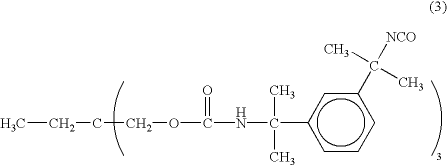

As the above-mentioned adducts, commercially available adducts including, for example, CYTHANE 3160 (trade name, manufactured by Mitsui Cytec, Ltd.) can also be used.

Such adducts may not always be OH:NCO complete adducts but may contain some unreacted starting materials.

The polyol used for the synthesis of the urethane prepolymer may be polyether polyols, polyester polyols and other polyols and mixed polyols composed of these polyols.

The polyether polyols include those polyether polyols obtained by adding, for example, one or more of propylene oxide, ethylene oxide, butylene oxide, styrene oxide, etc. to one or more of polyhydric alcohols such as ethylene glycol, diethylene glycol, propylene glycol, dipropylene glycol, glycerol, 1,1,1-trimethylolpropane, 1,2,5-hexanetriol, 1,3-butanediol, 1,4-butanediol, 4,4′-dihydroxyphenylpropane, 4,4′-dihydroxyphenylmethane and pentaerythritol. Specific examples thereof include polyoxypropylene glycol, polyoxyethylene glycol, polyoxypropylene triol, polytetramethylene glycol obtained by ring opening polymerization of tetrahydrofuran, etc.

The polyester polyols include polycondensates of one or more of ethylene glycol, propylene glycol, butanediol, pentanediol, hexanediol, cyclohexane dimethanol, glycerol, 1,1,1-trimethylolpropane and other low molecular weight polyols with one or more of glutaric acid, adipic acid, pimelic acid, suberic acid, sebacic acid, terephthalic acid, isophthalic acid, and other low molecular weight carboxylic acids and oligomer acids thereof; ring opening polymers of propiolactone, valerolactone, caprolactone, etc.

Examples of other polyols include polymer polyols; polycarbonate polyols; polybutadiene polyols; hydrogenated polybutadiene polyols; acrylic polyols; low molecular weight polyols such as ethylene glycol, diethylene glycol, propylene glycol, dipropylene glycol, butanediol, pentanediol, and hexanediol.

Among them, polyether polyols having a number average molecular weight of 1,500 to 15,000, in particular polyether polyols having a number average molecular weight of 2,000 to 10,000 are preferred in consideration of having excellent physical properties after curing.

These polyols may be used singly or as combinations of two or more of them.

The urethane prepolymer can be obtained by the reaction of a polyol with an excess amount of polyisocyanate. The mixing ratio of the polyol and polyisocyanate is preferably such that the ratio of the isocyanate group in the polyisocyanate to the hydroxyl group in the polyol (NCO/OH) is in a range of 1.3 to 2.5, more preferably 1.5 to 2.0. If the ratio is in this range, the urethane prepolymer has a suitable viscosity and the cured product has excellent elongation.

The urethane prepolymer can be produced by using the same method as used in the production of ordinary urethane prepolymers. For example, the urethane prepolymer can be obtained by stirring a polyol and a polyisocyanate in the above-mentioned ratio with heating at 50 to 100° C. If necessary, catalysts for urethanization such as organotin compounds, organobismuth, and amines may be used.

As stated above, urethane prepolymers having an isocyanate group bonded to a secondary aliphatic carbon atom in the molecule, urethane prepolymers having an isocyanate group bonded to a tertiary aliphatic carbon atom in the molecule, and urethane prepolymers having an isocyanate group bonded to a secondary aliphatic carbon atom and another isocyanate group bonded to a tertiary aliphatic carbon atom in the molecule can be obtained. These urethane prepolymers may be used singly or as combinations of two or more of them.

The secondary amine used as a blocking agent for the above-mentioned urethane prepolymers is not particularly limited and any blocking agent may be used so far as it has a substituent at at least one carbon atom at the α-position of the nitrogen atom in the imino group (NH) of the secondary amine. Specific examples thereof include diisopropylamine, 2,6-diemthylpiperidine, N-ethylcyclohexylamine, N-isopropylcyclohexylamine, N-methylcyclohexylamine, di-sec-butylamine, N-ethyl-1,2-dimethylpropylamine, N-methylisopropylamine, 2-pipecoline, 2,4-dimethylpiperidine, N-cyclohexylaniline, 2,5-dimethylpiperazine, 2,2,6,6-tetramethylpiperidine, 2,2,6,6-tetramethyl-4-piperidone, dicyclohexylamine, etc.

Among them, secondary amines having a methyl group bonded to each of the two carbon atoms at the α-positions of the nitrogen atom of the amine are preferred because of their particularly excellent curabilities. Specific examples of such secondary amines include diisopropylamine, 2,6-dimethylpiperidine, di-sec-butylamine, 2,2,6,6-tetramethylpiperidine, 2,2,6,6-tetramethyl-4-piperidone, dicyclohexylamine, etc.

The above-mentioned secondary amines may be used singly or as combinations of two or more of them.

The blocked urethane used in the first aspect of the present invention comprises an urethane prepolymer having an isocyanate group which is bonded to the secondary or tertiary aliphatic carbon atom, and is blocked with the secondary amine of the above-mentioned structure.

The production method for the blocked urethane is not particularly limited but the blocked urethane can be obtained by stirring the above-mentioned urethane prepolymer and secondary amine with heating preferably at 50 to 100° C. The reaction between the urethane prepolymer and the secondary amine may be performed by preliminarily reacting them to form a blocked urethane, and then, mixing it with the composition, or by simultaneously adding them at the time of adding the amine curing agent and allowing them to react with each other in the reaction system. In this case, the reaction temperature may be room temperature or elevated temperature as high as about 50 to about 100° C.

The mixing ratio of the urethane prepolymer and the secondary amine, i.e., the ratio of the imino group (NH) in the secondary amine to the isocyanate group (NCO) in the urethane prepolymer (NH/NCO), is preferably in a range of 0.03 to 1.0 and more preferably in a range of 0.1 to 1.0.

The amine latent curing agent used in the first aspect of the present invention is a compound that does not function as a curing agent until an amine is reproduced therefrom as a result of a hydrolysis reaction with water, and that is hydrolyzed with the moisture in the air or with the water contained in the composition to reproduce an amine.

As such an amine latent curing agent, all the conventionally known latent curing agents that can reproduce amines having a higher activity than that of the secondary amine as a blocking agent for NCO upon hydrolysis reaction, and that are usable as a latent curing agent for urethane resin compositions may be used.

In the one-pack curable resin composition according to the first aspect of the present invention, in terms of the compounding amount of the amine latent curing agent, the ratio of the total isocyanate group (NCO) in the urethane prepolymer as a starting material of the blocked urethane to the imino group (NH) or amino group (NH₂) in the curing agent after hydrolysis(NCO/(NH or NH₂)) is preferably in a range of 1 to 10, more preferably in a range of 1 to 5, and most preferably in a range of 1 to 2.

Preferred amine latent curing agents include (1) ketimines and aldimines, which are reaction products between polyamines and carbonyl compounds, and (2) silicon-containing ketimines and aldimines, which are reaction products between aminoalkoxysilanes and carbonyl compounds, and those amine latent curing agents can reproduce a primary amine as a result of hydrolysis.

The carbonyl compounds, which are starting materials of ketimines and aldimines, are preferably those ketones and aldehydes having a substituent bonded to the carbon atom at the α-position of the carbonyl carbon atom because of their excellent balance between storage stability and curing rate. Such ketones and aldehydes include those compounds represented by the following formula (3).

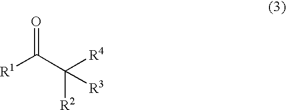

In the formula (3) above, R¹ represents a hydrogen atom or a methyl group; R² represents an alkyl group having 1 to 6 carbon atoms; R³ represents a methyl group or an ethyl group; and R⁴ represents a hydrogen atom, a methyl group or an ethyl group.

Here, the alkyl group having 1 to 6 carbon atoms represented by R² includes a methyl group, an ethyl group, a propyl group, a butyl group, a pentyl group, a hexyl group, and the like. Furthermore, R² and R³ may be taken together to form a cyclic group. Also, R¹ and R² may be also taken together to form a cyclic group.

As such compounds are preferred methyl isopropyl ketone (MIPK), methyl t-butyl ketone (MTBK), methyl cyclohexyl ketone, methyl cyclohexanone, etc.

Polyamines to be used in the synthesis of ketimines and aldimines are not particularly limited so far as they have two or more primary amino groups, but aliphatic polyamines are preferred because of their excellent curing rates.

Aliphatic polyamines include 2,5-dimethyl-2,5-hexamethylenediamine, menthenediamine, 1,4-bis(2-amino-2-methylpropyl)piperazine, polypropylene glycols (PPG) having amino groups bonded to the branching carbons of the propylene at both ends of the molecule (for example, “Jeffamin D230,” “Jeffamin D400,” etc., manufactured by Sun Technochemicals Co., Ltd.), ethylenediamine, propylenediamine, butylenediamine, diethylenetriamine, triethylenetetramine, tetraethylenepentamine, pentaethylenehexamine, hexamethylenediamine, trimethylhexamethylenediamine, N-aminoethylpiperazine, 1,2-diaminopropane, iminobispropylamine, methyliminobispropylamine, diamines having a polyether skeleton having a methylene group bonded to the nitrogen atoms in the amine, such as H₂N(CH₂CH₂O)₂(CH₂)₂NH₂ (“Jeffamin EDR148,” manufactured by Sun Technochemicals Co., Ltd.), 1,5-diamino-2-methylpentane (“MPMD,” trade name, manufactured by DuPont Japan Co., Ltd.), metaxylylenediamine (MXDA), polyamideamine (“X2000,” trade name, manufactured by Sanwa Chemical Co., Ltd.), isophoronediamine, 1,3-bisaminomethylcyclohexane (“1,3BAC”, trade name, manufactured by Mitsubishi Gas Chemical Company Inc.), 1-cyclohexylamino-3-aminopropane, 3-aminomethyl-3,3,5-trimethylcyclohexylamine, dimethyleneamines having a norbornane skeleton (“NBDA”, trade name, manufactured by Mitsui Chemical Inc.), etc. Among them, 1,3-bisaminomethylcyclohexane, dimethyleneamines having a norbornane skeleton, metaxylylenediamine, H₂N (CH₂CH₂O)₂(CH₂)₂NH₂, and polyamideamine are preferred because they have particularly high curing rates.

The compounds advantageously used as ketimines or aldimines, which is a reaction product between polyamines and carbonyl compounds, include products obtained from MIPK or MTBK and H₂N(CH₂CH₂O)₂(CH₂)₂NH₂, those obtained from MIPK or MTBK and 1,3-bisaminomethylcyclohexane, those obtained from MIPK or MTBK and a dimethyleneamine having a norbornane skeleton (NBDA), those obtained from MIPK or MTBK and MXDA, those obtained from MIPK or MTBK and a polyamideamine, etc from the viewpoint of storage stability and curing rate.

Among them, those obtained from MIPK or MTBK and a dimethyleneamine having a norbornane skeleton (NBDA) and those obtained from MIPK or MTBK and 1,3-bisaminomethylcyclohexane are preferred because of their particularly excellent curabilities. Also, those obtained from MIPK or MTBK and a polyamideamine are preferred because of their particularly excellent adhesive properties to wet surfaces.

Such ketimines and aldimines can be obtained by reacting a carbonyl compound and a polyamine by heating them under reflux in the absence of solvents or in the presence of a solvent such as benzene, toluene or xylene while removing water released by azeotropy.

Preferred aminoalkoxysilanes to be used in the synthesis of silicon-containing ketimines or aldimines include compounds represented by the following formula (4).

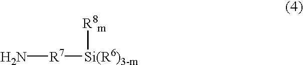

In the formula (4) above, R⁶ represents an alkyl group having 1 to 6 carbon atoms, an alkoxyl group having 1 to 6 carbon atoms, or a monovalent siloxane derivative group. The alkyl group having 1 to 6 carbon atoms is preferably a methyl group, an ethyl group, a propyl group, or the like. The alkoxyl group having 1 to 6 carbon atoms is preferably a methoxy group, an ethoxy group, a propoxy group, or the like. The monovalent siloxane derivative group is preferably a silyloxy group, or the like. Among them, a methoxy group and an ethoxy group are particularly preferred for R⁶.

R⁷ represents a divalent hydrocarbon group that may have a nitrogen atom, preferably a divalent hydrocarbon group having 1 to 6 carbon atoms. Preferred examples of the divalent hydrocarbon group containing no nitrogen atom include a methylene group, an ethylene group, a propylene group, etc. Preferred examples of the divalent hydrocarbon group containing a nitrogen atom include those groups exemplified as the above-mentioned divalent hydrocarbon groups containing no nitrogen atom but containing an imino group (NH) in the hydrocarbon group. Among them, particularly preferred as R⁷ are a methylene group, a propylene group, and a —C₂H₄NHC₃H₆— group.

R⁸ represents an alkoxyl group, preferably an alkoxyl group having 1 to 6 carbon atoms. Particularly preferred as R⁸ are a methoxy group and an ethoxy group.

m is 0, 1, 2 or 3.

The aminoalkoxysilanes represented by the formula (4) above include, for example, the compounds represented by the following formulae (5) to (12). Among them, the compounds represented by the formulae (5) to (8) are preferred. It should be noted that the compounds represented by the formulae (5) to (8) are also known as general-purpose silane coupling agents.

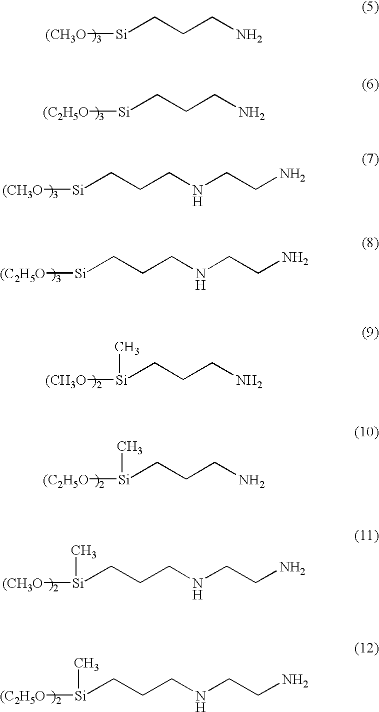

The silicon-containing ketimines or aldimines, which are reaction products between such an aminoalkoxysilane and a carbonyl compound are compounds represented by the following formula (13).

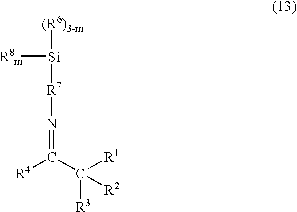

In the formula (13), R¹ to R⁴ have the same meanings as the R¹ to R⁴ in the formula (3), and R⁶ to R⁸ and m have the same meanings as the R⁶ to R⁸ and m in the formula (4).

Further, the silicon-containing ketimines or aldimines may be polycondensates having the structure represented by the following formula (14) as a main chain structure.

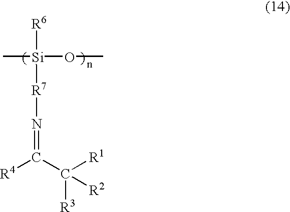

In the formula (14) above, R¹ to R⁷ have the same meanings as the R¹ to R⁷ in the general formula (13), and n is an integer of 1 or more, preferably 1 to 50.

The silicon-containing polycondensates thus obtained may have bonded to the terminals of the main chain thereof: a hydrogen atom, an alkyl group having 1 to 6 carbon atoms, such as a methyl group, an ethyl group, and a propyl group; an alkoxyl group having 1 to 6 carbon atoms, such as a methoxy group, an ethoxy group and a propoxy group; or a monovalent siloxane derivative group such as a silyloxy group.

Such silicon-containing ketimines or aldimines can be obtained by dehydration reaction performed by stirring an aminoalkoxysilane and a carbonyl compound at room temperature or with heating. The reaction temperature is preferably 20 to 150° C., more preferably 50 to 110° C. The reaction time is preferably 2 to 24 hours and more preferably 2 to 5 hours.

The one-pack curable resin composition according to the first aspect of the present invention may contain in addition to the blocked urethane and amine latent curing agent, various additives such as fillers, plasticizers, antioxidants, age resistors, inorganic pigments, organic pigments, tackifiers, flame retardants, dehydrating agents, solvents, silane coupling agents, thixotropy-imparting agents, and antistatic agents.

The fillers include organic or inorganic fillers of various shapes. Specific examples thereof include fumed silica, calcined silica, precipitated silica, pulverized silica, molten silica; diatomaceous earth; iron oxide, zinc oxide, titanium oxide, barium oxide, magnesium oxide; calcium carbonate, magnesium carbonate, zinc carbonate; agalmatolite clay, kaolin clay, calcined clay; carbon black; and fatty acid-, resin acid-, fatty acid ester- or urethane compound-treated products of them.

The plasticizers that can be used include diisononyl adipate, dioctyl phthalate, dibutyl phthalate, butyl benzyl phthalate, dioctyl adipate, isodecyl succinate, diethylene glycol dibenzoate, pentaerythritol esters, butyl oleate, methyl acetyl ricinolate, tricresyl phosphate, trioctyl phosphate, polyesters of adipic acid and propylene glycol, polyesters of adipic acid and butylene glycol, etc.

The antioxidants that can be used include butylhydroxytoluene, butylhydroxyanisole, triphenyl phosphite, etc.

The age resistors that can be used include compounds such as hindered phenols, benzotriazoles, hindered amines, etc.

The inorganic pigments that can be used include titanium dioxide, zinc oxide, ultramarine blue, red iron oxide, lithopone, lead, cadmium, iron, cobalt, aluminum, hydrochlorides, sulfates, etc.

The organic pigments that can be used include azo pigments, copper phthalocyanine pigments, etc.

The tackifiers that can be used include terpene resins, phenol resins, terpene/phenol resins, rosin resins, xylene resins, etc.

The flame retardants that can be used include halogen/phosphorus compounds such as chloroalkyl phosphates; phosphorus compounds such as dimethyl/methyl phosphonates, ammonium polyphosphates, diethyl/bishydroxyethyl/aminoethyl phosphates; bromine compounds such as neopentyl bromide/polyethers, brominated polyethers, etc.

The dehydrating agents that can be used include acyloxysilyl group-containing polysiloxanes, etc.

The one-pack curable resin composition according to the first aspect of the present invention can be produced by sufficiently kneading the above-mentioned components under reduced pressure or in the presence of nitrogen by using a mixing apparatus such as a blending mixer to uniformly disperse them.

The one-pack curable resin composition according to the first aspect of the present invention is very excellent in storage stability, and at the time of use, the amine latent curing agent is hydrolyzed with moisture in atmosphere and it has excellent workability since it cures in a suitable usable life at room temperature. Also under high temperature and high humidity conditions, it can maintain satisfactory storage stability and a usable life.

The one-pack curable resin composition according to the first aspect of the present invention is suitable for use in sealing materials, adhesives, coating materials, primers, coating compositions, etc.

Next, the second aspect of the present invention will be described.

According to the second aspect, the present invention provides a two-pack curable resin composition comprising the above-mentioned block urethane and an amine curing agent that are separated in a storage condition but mixed with each other at the time of use.

The two-pack curable resin composition according to the second aspect comprises a blocked urethane comprising an urethane prepolymer having an isocyanate group which is bonded to a secondary or tertiary aliphatic carbon atom, and is blocked with a secondary amine having a substituent which is bonded to a carbon atom at an α-position of the nitrogen atom of the amine, and an amine curing agent.

The blocked urethane that can be used in the second aspect may be the same as that used in the first aspect.

The amine curing agent used in the second aspect is not particularly limited so far as it is a compound that reproduces an amine having a higher activity than that of the secondary amine used as a blocking agent for NCO, and the aliphatic polyamines as used in the first aspect, aromatic polyamines such as metaphenylenediamine, diaminodiphenylmethane, diaminodiphenylsulfone, and diaminodiethyldiphenylmethane, or the like may be used.

Among those amine curing agents, aliphatic polyamines having two or more primary amino groups are preferred because of their excellent curabilities.

In the second aspect, in terms of the compounding amount of the amine curing agent, the ratio of the total isocyanate group (NCO) in the urethane prepolymer as a starting material of the blocked urethane to the imino group (NH) or amino group (NH₂) in the curing agent after hydrolysis (NCO/(NH or NH₂)) is preferably in a range of 1 to 10, more preferably in a range of 1 to 5, and most preferably in a range of 1 to 2.

The two-pack curable resin composition of the second aspect may contain in addition to the above-mentioned blocked urethane and amine curing agent, various additives in amounts within which they do not harm the effect of the present invention. The additives that can be used may be the same as those used in the first aspect.

The two-pack curable resin compositions as described above can be produced by sufficiently kneading the blocked urethane and additives which are components other than the amine curing agent in advance under reduced pressure or in the presence of nitrogen by using a mixing apparatus such as a mixer, and the kneaded mixture is mixed with the amine curing agent at the time of use.

The two-pack curable resin composition according to the second aspect has very excellent storage stability, and at the time of use, it has excellent workability since it cures in a suitable usable life at room temperature. Also under high temperature and high humidity conditions, it can maintain satisfactory storage stability and a usable life.

The two-pack curable resin composition according to the second aspect, like the one-pack curable resin composition according to the first aspect, is suitable for use in sealing materials, adhesives, coating materials, primers, coating compositions, etc.

### EXAMPLES

Hereinafter, the present invention will be illustrated in more detail by way of examples. However, the scope of the present invention should not be considered to be limited to the following examples.

Urethane prepolymers A and B, and ketimine C used as starting materials for preparing the compositions of Examples 1 to 5 were synthesized as described below.

(1) Synthesis of Urethane Prepolymer A

Tetramethylxylylene diisocyanate (TMXDI) (manufactured by Mitsui Cytec, Ltd.) and trifunctional polypropylene glycol (“Excenol 5030,” trade name, manufactured by Asahi Glass Co., Ltd.) were mixed in an NCO/OH ratio of 2.0 and the mixture was stirred with heating at 80° C. overnight to obtain the objective urethane prepolymer A.

(2) Synthesis of Urethane Prepolymer B

The objective urethane prepolymer B was obtained in the same manner as urethane prepolymer A except that TMXDI was replaced by tolylene diisocyanate (“Cosmonate T-80,” trade name, manufactured by Mitsui Chemical, Inc.).

(3) Synthesis of Ketimine C

In a flask were charged 100 g of dimethylenediamine having a norbornane skeleton (NBDA) (manufactured by Mitsui Chemical, Inc.) and 167 g of methyl isopropyl ketone (MIPK) together with 200 g of toluene and allowed to react for 20 hours while removing the water generated by azeotropy. Thereafter, toluene and excessive MIPK were removed by distillation to obtain the objective ketimine.

One-pack curable resin compositions of Examples 1 to 5 and Comparative Examples 1 to 3 were produced and curabilities and storage stabilities thereof were evaluated.

### Example 1

A blocked urethane obtained by stirring a mixture (NH/NCO=1.0) of 100 parts by weight of urethane prepolymer A and 4.8 parts by weight of diisopropylamine with heating at 80° C. for 2 hours, ketimine C, and diisononyl adipate as a plasticizer in ratios described in Table 1 were sufficiently kneaded by using a mixer under reduced pressure so as to uniformly disperse to obtain a composition. The composition had the ratio of the urethane prepolymer to ketimine (NCO/NH₂) of 1.0.

### Example 2

A composition was obtained in the same manner as in Example 1 except that the addition amount of diisopropylamine was changed to 3.6 parts by weight (NH/NCO=0.75). The composition had the NCO/NH₂ ratio of 1.0.

### Example 3

A composition was obtained in the same manner as in Example 1 except that in place of diisopropylamine, 5.3 parts by weight (NH/NCO=1.0) of 2,6-dimethylpiperidine was used. The composition had the NCO/NH₂ ratio of 1.0.

### Example 4

A composition was obtained in the same manner as in Example 1 except that in place of diisopropylamine, 6.1 parts by weight (NH/NCO=1.0) of N-ethylcyclohexylamine was used. The composition had the NCO/NH₂ ratio of 1.0.

### Example 5

A composition was obtained in the same manner as in Example 1 except that in place of diisopropylamine, 6.6 parts by weight (NH/NCO=1.0) of N-isopropylcyclohexylamine was used. The composition had the NCO/NH₂ ratio of 1.0.

### Comparative Example 1

A composition was obtained in the same manner as in Example 1 except that urethane prepolymer A was used without blocking it.

### Comparative Example 2

A composition was obtained in the same manner as in Example 1 except that in place of diisopropylamine, 6.1 parts by weight of dibutylamine having no substituent at the α-position of the nitrogen atom thereof was used.

### Comparative Example 3

A composition was obtained in the same manner as in Example 1 except that in place of urethane prepolymer A, urethane prepolymer B was used.

The curabilities and storage stabilities of the obtained compositions were evaluated by the following methods. The results as shown in Table 1 were obtained.

Curability Tests

The obtained compositions were left to stand under the conditions of the temperature of 20° C. and the relative humidity (RH) of 55% and the time until the tack on the surface disappeared was measured according to JIS-A-5758.

Storage Stability Tests

The viscosity immediately after the preparation and the viscosity after aging at 70° C. for 1 day of the obtained compositions were measured by using an E-type viscometer and the rates of rise (fold) of the viscosity after aging at 70° C. for 1 day to the viscosity immediately after the preparation were compared to evaluate the storage stabilities of the compositions.

TABLE 1
(Unit of the content of component: part by weight)

| | Example | | | | | Comparative Example | | |
|---|---|---|---|---|---|---|---|---|
| | 1 | 2 | 3 | 4 | 5 | 1 | 2 | 3 |
| Urethane prepolymer A | 100 | 100 | 100 | 100 | 100 | 100 | 100 | |
| Urethane prepolymer B | | | | | | | | 100 |
| Diisopropylamine | 4.8 | 3.6 | | | | | | 4.8 |
| 2,6-Dimethylpiperidine | | | 5.3 | | | | | |
| N-ethylcyclohexylamine | | | | 6. 1 | | | | |
| N-isopropylcyclohexylamine | | | | | 6.6 | | | |
| Dibutylamine | | | | | | | 6.1 | |
| Ketimine C | 7 | 7 | 7 | 7 | 7 | 7 | 7 | 7 |
| NBDA | | | | | | | | |
| Plasticizer | 20 | 20 | 20 | 20 | 20 | 20 | 20 | 20 |
| Curability (Time) | 24 | 13 | 15 | 24 | 22 | 3 | Not | Not |
| | | | | | | | cured | cured |
| Storage Stability (Fold) | 1.3 | 1.3 | 1.4 | 1.2 | 1.2 | 3.2 | 1.1 | 1.1 |

Next, the two-pack curable resin compositions of Example 6 and Comparative Example 4 were produced and usable lives thereof were compared as described below.

### Example 6

To a mixture solution composed of a blocked urethane obtained by stirring a mixture (NH/NCO=1.0) of 100 parts by weight of urethane prepolymer A and 4.8 parts by weight of diisopropylamine with heating at 80° C. for 2 hours, and 20 parts by weight of diisononyl adipate as a plasticizer was added 3.7 parts by weight of dimethylenediamine having a norbornane skeleton (NBDA) (manufactured by Mitsui Chemical Inc.). The obtained mixture was sufficiently kneaded by using a mixer so as to uniformly disperse to obtain a composition. The composition had the ratio of the urethane prepolymer to the amine curing agent (NCO/NH₂) of 1.0. When the composition was left to stand under the conditions of the temperature of 20° C. and the relative humidity (RH) of 55%, it took 5 hours or more until it cured, so that a sufficient usable life could be maintained.

### Comparative Example 4

To a mixture solution composed of 100 parts by weight of urethane prepolymer A and 20 parts by weight of diisononyl adipate was added 3.7 parts by weight of NBDA. However, after stirring, the composition was gelled in several seconds, so that no sufficient usable life could be obtained.

Furthermore, the mixture solutions as described in Examples 7 and Comparative Example 5 were produced and the stabilities of the prepolymers were compared.

### Example 7

100 parts by weight of the blocked urethane produced in the same manner as in Example 6 and 20 parts by weight of diisononyl adipate were sufficiently kneaded by using a mixer to obtain a mixture solution. When the mixture solution was left to stand under the conditions of the temperature of 20° C. and the relative humidity of 55%, no curing was observed even after 1 week.

### Comparative Example 5

100 parts by weight of urethane prepolymer B and 20 parts by weight of diisononyl adipate were sufficiently kneaded by using a mixer to obtain a mixture solution. The mixture solution cured in 1 day under the same conditions as in Example 7.

According to the present invention, the curable resin composition has excellent storage stability since the urethane polymer therein is blocked prior to using the composition, and at the time of using it, the blocked urethane prepolymer is unblocked in the presence of amine curing agent at room temperature and cures in a suitable usable life, so that a one-pack or two-pack curable resin composition having excellent workability can be obtained. Such curable resin compositions can maintain good storage stabilities and sufficient usable lives even under high temperature and high humidity conditions.

What is claimed is:

1. A one-pack curable resin composition comprising:
a blocked urethane prepolymer comprising an urethane prepolymer having an isocyanate group which is bonded to a secondary or tertiary aliphatic carbon atom, and is blocked with a secondary amine having a substituent which is bonded to a carbon atom at an α-position of the nitrogen atom of the amine, and
an amine latent curing agent.

2. A one-pack curable resin composition according to claim 1, wherein the secondary amine is a secondary amine having a methyl group bonded to each of the two α-carbon atoms adjacent to the nitrogen atom of the amine.

3. A one-pack curable resin composition according to claim 1, wherein the amine latent curing agent is a compound selected from the group consisting of a ketimine and an aldimine.

4. A one-pack curable resin composition according to claim 2, wherein the amine latent curing agent is a compound selected from the group consisting of a ketimine and an aldimine.

5. A one-pack curable resin composition according to claim 3, wherein the compound selected from the group consisting of a ketimine and an aldimine is derived from a ketone or an aldehyde having a substituent at an α-carbon atom of a carbonyl carbon atom in the ketone or aldimine.

6. A one-pack curable resin composition according to claim 4, wherein the compound selected from the group consisting of a ketimine and an aldimine is derived from a ketone or an aldehyde having a substituent at an α-carbon atom of a carbonyl carbon atom in the ketone or aldimine.

7. A two-pack curable resin composition comprising:
a blocked urethane prepolymer comprising an urethane prepolymer having an isocyanate group which is bonded to a secondary or tertiary aliphatic carbon atom, and is blocked with a secondary amine having a substituent which is bonded to a carbon atom at an α-position of the nitrogen atom of the amine, and
an amine curing agent.
